(19) United States
(12) Patent Application Publication
(10) Pub. No.: US 2012/0024550 A1
(43) Pub. Date: Feb. 2, 2012

(54) Guidance Tool for Landscaping Implements

(76) Inventor: Roger H. Woods, Watford (CA)

(21) Appl. No.: 13/188,504

(22) Filed: Jul. 22, 2011

Related U.S. Application Data
(60) Provisional application No. 61/369,695, filed on Jul. 31, 2010.

(51) Int. Cl. A01B 76/00

(52) U.S. Cl. 172/24

(57) ABSTRACT

A landscaping tool for guiding a landscaping implement around an object of a landscape, such as a tree, post, or other relatively fixed structure is disclosed. The landscaping tool includes an engagement segment, such as a hook, for engaging the object, a body portion extending from the engagement segment, and a repositionable coupler provided on the body portion that is used for attaching the tool to the landscaping implement.

### CROSS-REFERENCE TO RELATED APPLICATION

The present application claims the benefit of U.S. Provisional Appl. No. 61/369,695, filed Jul. 31, 2010, which is incorporated by reference herein in its entirety.

### FIELD OF THE INVENTION

The present invention relates generally to landscaping tools, and more specifically to a landscaping tool that permits guidance of a landscaping implement around an object such as a tree or pole.

### BACKGROUND OF THE INVENTION

Gardening, and more generally landscaping has long been a popular pastime around the world. In recent times, there has been increasing attention to do-it-yourself approaches to all aspects of home and garden beautification. The complexity of residential and commercial landscaping has increased considerably, with gardeners and landscapers seeking new tools and methods to achieve their design goals.

In many respects, landscaping has become an art form, where accurate and precise arrangement and trimming of the gardening/landscaping space is paramount. However there is a lack of guidance/assistance tooling for use in maintaining a gardening/landscaping implement in a desirable orientation relative to an object in a landscape that also permits a high level of accuracy or control in achieving a certain landscaping feature or pattern.

There is a need in the landscaping market for specialized tooling that provides a landscaper, or more generally any user with enhanced guidance, so as to achieve a desired level of precision and accuracy in achieving a certain landscaping feature or pattern when using landscaping implements.

### SUMMARY OF THE INVENTION

According to an aspect of the invention, provided is a landscaping tool for guiding a landscaping implement around an object of a landscape, such as a tree, post, or other relatively fixed structure. The landscaping tool includes an engagement segment, such as a hook, for engaging the object, a body portion extending from the engagement segment, and a repositionable coupler provided on the body portion. The coupler includes an attachment fixture to permit the mounting of a landscaping implement, wherein the rotation of the landscaping tool around the object maintains the landscaping implement at a predetermined distance or orientation relative to the object.

### DESCRIPTION OF THE DRAWINGS

The foregoing and other features and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a perspective view of a first embodiment of the landscaping tool, coupled to a marking device.

FIG. 2 is a perspective view of the coupler of the landscaping tool of FIG. 1.

FIG. 3A is a perspective view of the landscaping tool of FIG. 1, showing rotation of the landscaping tool and the mounted landscaping implement (e.g. marking device) around an object (e.g. tree).

FIG. 3B is a top a view of the landscaping toll shown in FIG. 3A showing the rotation of the landscaping tool around an object.

FIG. 4A is a perspective view of an engagement segment of a landscaping tool in accordance with another embodiment hereof.

FIG. 4B is a top view of an engagement segment of a landscaping tool in accordance with another embodiment hereof.

FIG. 5 is a top view of an engagement segment of a landscaping tool in accordance with another embodiment hereof.

FIG. 6 is a perspective view of a landscaping tool having a body portion that includes a telescoping arrangement in accordance with another embodiment hereof.

FIG. 7 is a perspective view of a landscaping tool having a body portion that is extendible by way of multiple extension sections in accordance with another embodiment hereof.

FIG. 8 is a perspective view of an alternate embodiment of a coupler for use with a landscaping tool hereof.

FIG. 9 is a perspective view of the landscaping tool of FIG. 1, showing a handle provided on the body portion.

### DETAILED DESCRIPTION OF THE INVENTION

Specific embodiments of the present invention are now described with reference to the figures. The following detailed description is exemplary in nature and is not intended to limit the invention or the application and uses of the invention. While described primarily in respect of landscaping and landscaping implements, the tool may find application in other areas such as, but not limited to the construction field.

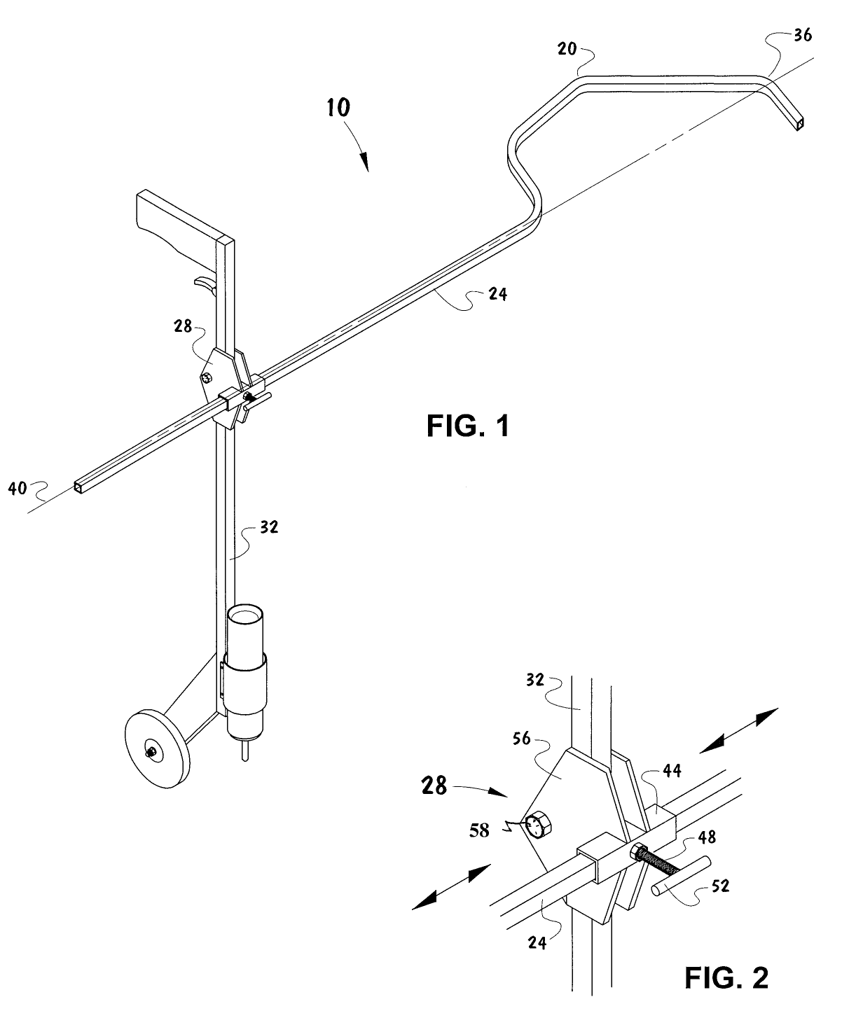

Shown in FIG. 1 is a landscaping tool 10 used to guide a landscaping implement 32 in a pattern, of predetermined distance, around an object, such as, but not limited to a tree, pole, telephone post, rock or statue. Exemplary landscaping implements 32 suitable for use with tool 10 include commercially available marking devices and wheeled edging tools, but as will be appreciated, a range of other landscaping implements may be suitable for use with tool 10. Where the landscaping implement 32 is shown in the drawings, it is generally represented as a marking device. Where the object around which the landscaping tool 10 is used in shown in the drawings, it is generally represented as a tree T. The use of the marking device and tree in the drawings is merely exemplary, and is not intended to limit the utility of the invention in any way.

The landscaping tool 10 includes an engagement segment or hook 20, a body portion 24 extending from engagement segment 20, and a coupler 28 for coupling landscaping implement 32 (e.g. marking device) to the landscaping tool 10. Coupler 28 is configured to be repositionable on body portion 24, so as to set coupler 28, and hence landscaping implement 32 at a predetermined distance and/or orientation from an object (e.g. tree T).

In the embodiment shown, engagement segment 20 is predominantly angular, with four segments defining the general form of a hook, but as will be appreciated, engagement segment 20 may include fewer or greater number of segments. Engagement segment 20 also provides an angled seat 36 into which the object is set for guiding tool 10. In general, angled seat 36 is configured to provide at least two points of contact with the object, so as to provide stability during rotation. As shown, angled seat 36 is generally aligned with a longitudinal axis 40 defined by body portion 24, but it will be appreciated that in other embodiments, angled seat 36 may be offset from longitudinal axis 40.

Body portion 24 extends from engagement segment 20, and is configured to extend radially outwardly from the object around which tool 10 is rotated. In the embodiment shown, body portion 24 is of fixed length, the length generally being suitable for setting a range of circular patterns around the object, depending on the position of adjustable coupler 28.

Coupler 28 is configured to enable attachment of landscaping implement 32 to landscaping tool 10. Depending on the desired circular pattern to be marked around the object, coupler 28 is repositionable on body portion 24 as determined by the user. As shown in FIG. 2, coupler 28 is configured for sliding engagement with body portion 24. In general, coupler 28 includes a sliding sleeve 44 with a releasable fastener 48 being provided to secure coupler 28 at a selected location on body portion 24. As shown, releasable fastener 48 is configured as a threaded screw with a handle 52 to facilitate adjustment. Coupler 28 also provides an attachment fixture 56 for mounting landscaping implement 32 on coupler 28. As will be appreciated, attachment fixture 56 may take on a variety of forms, so as to match the shape/dimensions of the commercially available landscaping implement 32. Attachment fixture 56 shown in FIG. 2 is an integral part of coupler 28. In other embodiments, attachment fixture 56 may be a detachable feature, and may be available in a range of configurations to suit a variety of landscaping implements. Adaptability of attachment fixture 56 to a variety of landscaping implements may be further facilitated through the use of an adaptor kit that provides a specific geometry for mating to the specific shape/dimension of a certain landscaping implement. As noted in FIG. 2, attachment fixture 56 includes a fastening mechanism 58 (e.g. threaded nut/bolt) to effectively tighten attachment fixture 56, such that landscaping implement 32 is fixedly retained. Although represented as a threaded nut/bolt, fastening mechanism 58 may take on a variety of forms, with the intended function being the secure retention of landscaping implement 32 on coupler 28.

It will be appreciated that landscaping tool 10 may be constructed from a range of materials, including metal and/or various polymers/resins, with the sections of tool 10 being of either tubular and/or solid construction. In the embodiment shown, engagement segment 20 and body portion 24 are constructed from square tubing. While square tubing facilitates alignment of coupler 28 on body portion 24, it will be appreciated that other cross-sectional configurations of material may be suitable implemented (e.g. circular). In an embodiment, aluminum or an aluminum-alloy may be used to facilitate lightweight construction.

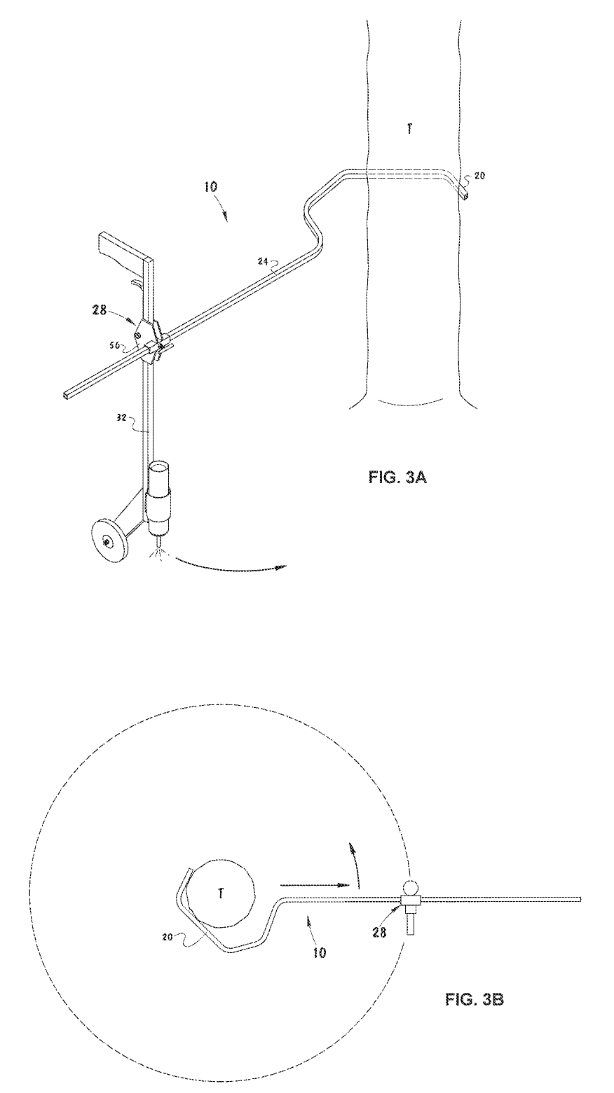

As indicated above, landscaping tool 10 is designed to be coupled to a range of separately available landscaping implements 32. For an explanation of use, reference will now be made to FIGS. 3A and 3B in which tool 10 and a coupled landscaping implement 32, in this case a marking device, are shown with reference to a tree T. In use, marking device 32 is attached to landscaping tool 10 by way of attachment fixture 56 of coupler 28, and the longitudinal position of coupler 28 on body portion 24 is selected for achieving the desired marking distance around tree T. Tool 10 is then hooked around tree T by virtue of engagement segment 20. While walking around the tree with tool 10, the user imparts an outwardly directed pressure to ensure accurate engagement with tree T, while at the same time triggering marking device 32 to release a marking product contained therein, for example a paint or marking powder onto the ground. With the surface around the tree now marked with a circular pattern, the user can proceed with landscaping around the tree as desired, using the marked circular pattern as a guide. In general, landscaping tool 10 permits for accurate and precise engagement of landscaping implement 32 with the surface being worked, using the object located at angular seat 36 as a reference point.

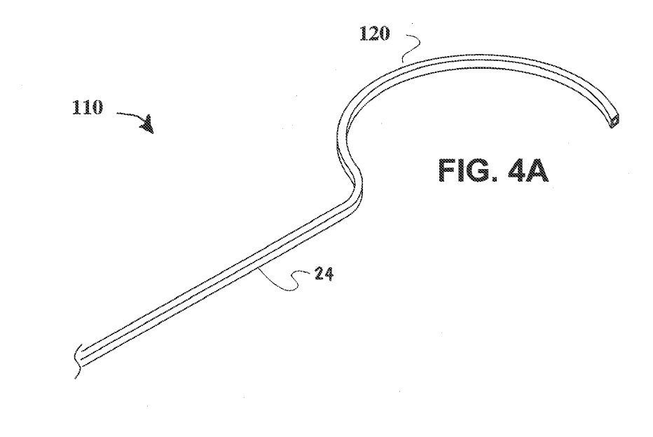

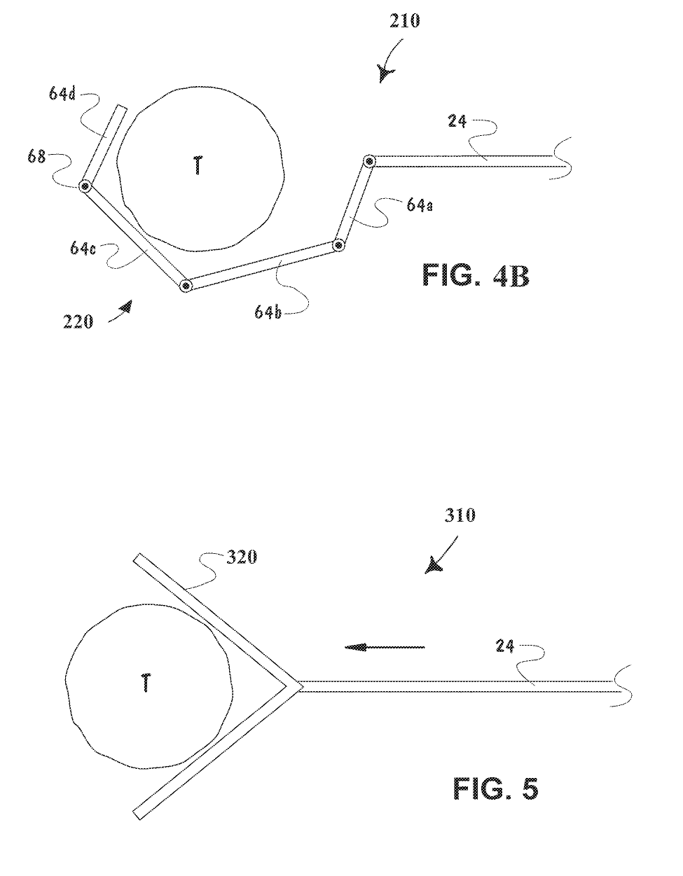

While presented as an angular arrangement, engagement segment 20 of landscaping tool 10 may take on a variety of forms, with the intended function of engagement segment 20 being the engagement of an object to provide support and guidance to the tool during use. In another embodiment hereof, landscaping tool 110 includes an engagement segment 120 having a predominantly rounded or curved configuration as shown in FIG. 4A. As will be appreciated, variations and/or combinations on these arrangements are possible. For example, in another embodiment, the engagement segment may have a predominantly rounded or curved configuration, as shown in FIG. 4A, with the addition of an angled seat, similar to angled seat 36 in the embodiment of FIG. 1, for engagement with the object. In another embodiment hereof shown in FIG. 4B, landscaping tool 210 includes engagement segment 220 formed from a number of adjustable sections. Engagement segment 220 includes four sections 64a, 64b, 64c, 64d that are interconnected by way of adjustable fasteners 68. Adjustable fasteners 68 permit the adaptation/reconfiguration of engagement segment 220, and generally landscaping tool 210 to different sized objects as necessary. Adjustability of engagement segment 220 may be in the form of altering the angles between the sections, and/or may include the interchangeability of differently sized sections. In general, the ability to adjust and/or reconfigure the shape of engagement segment 220 enables a user to customize tool 110 to suit a range of objects around which tool 210 is being rotated. The ability to reconfigure engagement segment 220 also permits for easier storage and retail packaging, as the generally bulkier engagement segment of landscaping tool 210 can be substantially collapsed.

While the engagement segments of the preceding embodiments are represented as generally hook-shaped, engagement segment 320 of landscaping tool 310 shown in FIG. 5 has a V-shape to contact an object on two inner sides. In this configuration, instead of applying an outwardly directed pressure in use, the user applies an inwardly directed pressure towards the object, as represented by the arrow in FIG. 5, to ensure engagement while directing landscaping tool 310 around the object.

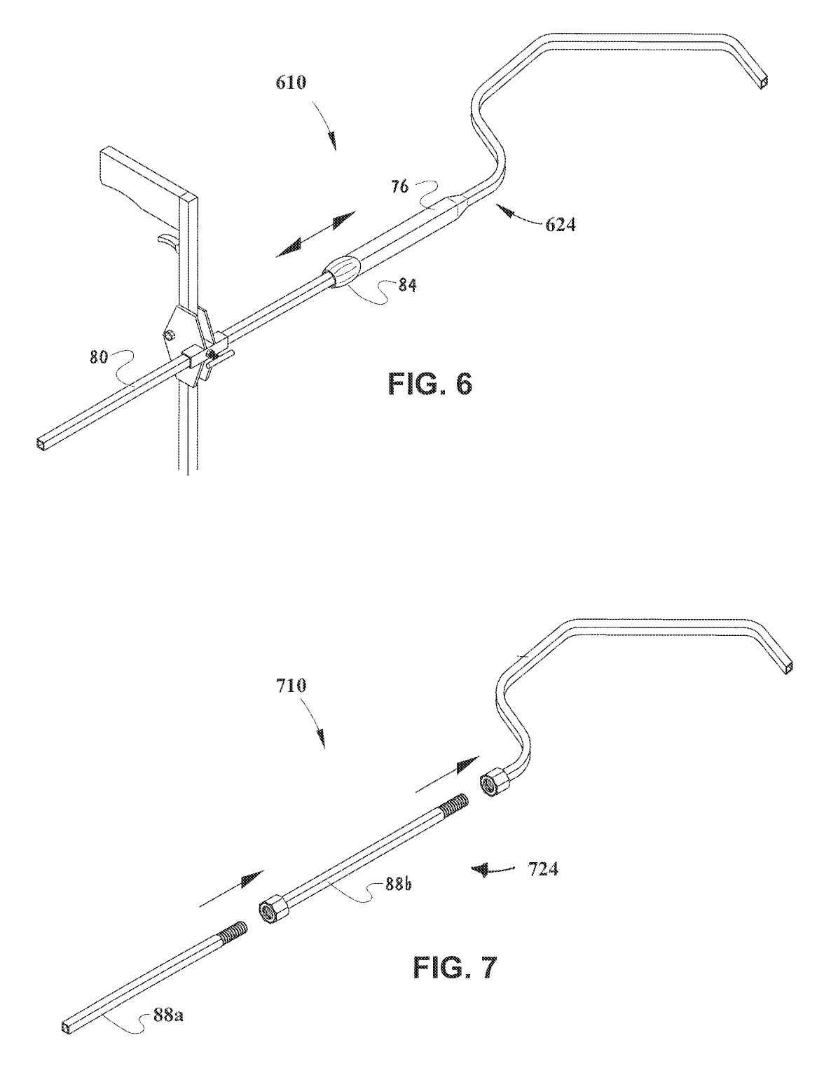

While body portion 24 is described in the embodiments above as being of fixed length, body portion 624 of landscaping tool 610 shown in FIG. 6 utilizes a telescoping construction in which multiple elongated body sections 76, 80 are coupled to seat in a telescoping relationship to permit for a wider range of adjustability in terms of length. In this way, the telescoping arrangement enables extension or retraction of body portion 624 as necessary for the landscaping application. To maintain the telescoping arrangement at a selected length, one or more locking fixtures 84 may be provided. In another embodiment shown in FIG. 7 in which coupler 28 is not shown for clarity, landscaping tool 710 includes body portion 724 defined by a plurality of sections 88a, 88b, which couple together, for example through threaded engagement, to form a desired length.

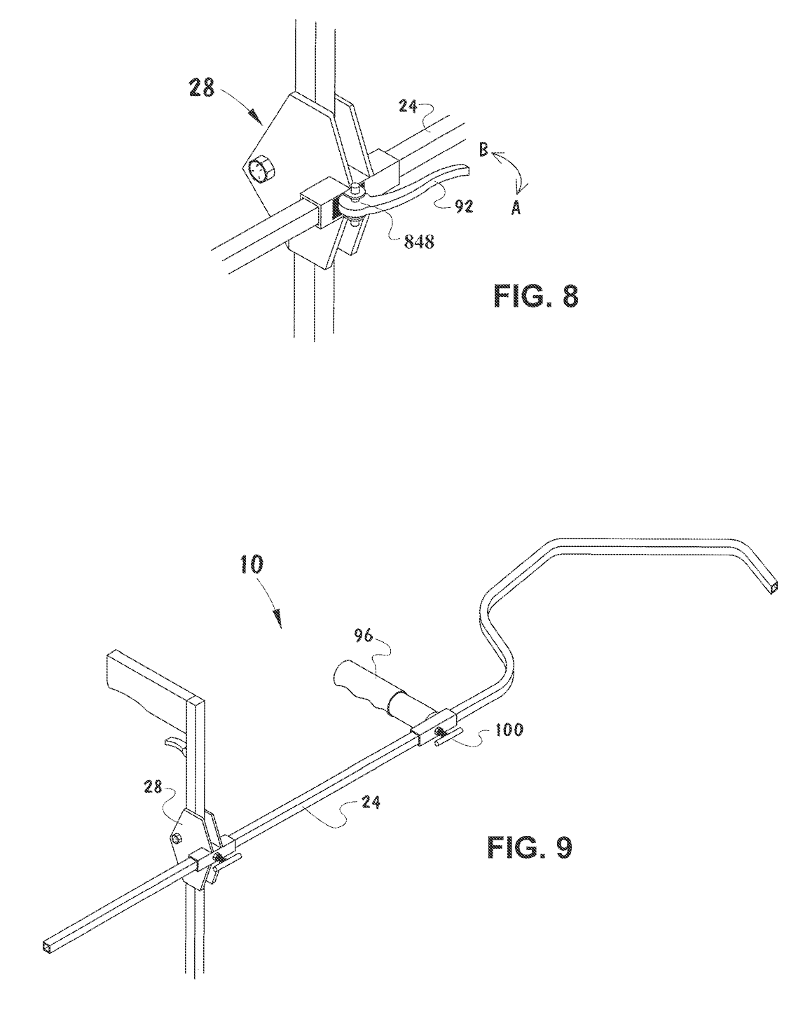

While releasable fastener 48 of coupler 28 is described above as having a threaded set screw, a variety of other fastening or locking arrangements are possible. For example, releasable fastener 48 may include a simple set screw that is adjustable by way of any standard screw and/or socket driver. Alternatively in another embodiment shown in FIG. 8, releasable fastener 848 includes a locking cam 92 that releasably engages body portion 24. In such an arrangement, locking cam 92 may be rotated between a first position A in which coupler 28 is free to slide on body portion 24 and a second position B that imparts a force on body portion 24, thereby retaining coupler 28 in a fixed position on elongated body 24.

To facilitate handling of landscaping tools in accordance with embodiments during usage, the tool may be provided with an adjustable handle 96 as shown in FIG. 9. Adjustable handle 96 is repositionable along body portion 24 to permit placement at a location comfortable to the user. In this way, during usage, the user is able to grasp adjustable handle 96, for example with their left hand, while guiding and operating landscaping implement 32 coupled to tool 10 with their right hand. Adjustable handle 96 is provided with a similar releasable fastener 100 as that described above with respect to coupler 28. While handle 96 is shown as being positioned generally in the same plane as engagement segment 20, handle 96 may be positioned to extend upwardly of tool 10, i.e., generally 90° to the plane of engagement segment 20. It will be further appreciated that where the material used to construct tool 10 is circular in cross-section, handle 96 may be positioned at any intermediate position that is comfortable for the user. Still further arrangements of handle 96 are possible, such as a handle that includes an adjustable hinge (not shown) to permit for angular adjustments.

While landscaping tool 10 has been shown as having a single hook structure, in some embodiments, landscaping tool 10 may include a plurality of spaced-apart hook structures to engage the object (e.g. tree) at multiple locations along the object's longitudinal axis. In such an arrangement, the multiple hook structures may be situated in parallel planes. In this way, the spaced-apart relationship of the plurality of hook structures provides additional stability when the tool 10 is situated on an object.

While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein can be used in combination with the features of any other embodiment.

What is claimed is:

1. A landscaping tool for guiding a landscaping implement around an object, comprising:
an engagement segment for engaging the object;
a body portion extending from said engagement segment; and
a repositionable coupler provided on said body portion, said coupler having an attachment fixture to permit the mounting of a landscaping implement,
wherein the rotation of the landscaping tool around the object maintains the landscaping implement at a predetermined distance around the object.

2. The landscaping tool according to claim 1, wherein said engagement segment is provided in the general form of a hook.

3. The landscaping tool according to claim 1, wherein said body portion is of fixed length.

4. The landscaping tool according to claim 1, wherein said coupler is configured for sliding engagement with said body portion.

5. The landscaping tool according to claim 4, wherein said coupler includes a sliding sleeve and a releasable fastener to secure said coupler at a selected location on said body portion.

6. The landscaping tool according to claim 1, wherein said attachment fixture includes a fastening mechanism to retain said landscaping implement on said coupler.

7. The landscaping tool according to claim 1, wherein said engagement segment is formed from a plurality of adjustable sections interconnected by adjustable fasteners.

8. The landscaping tool according to claim 1, wherein said engagement segment is provided in the form of a V-shape.

9. The landscaping tool according to claim 1, wherein said body portion is composed of multiple elongated body sections coupled to seat in telescoping relationship, and a locking feature to maintain the telescoping relationship at a selected length.

10. The landscaping tool according to claim 1, wherein said body portion is defined by a plurality of sections which couple together through threaded engagement, the number of sections defining the desired length.

11. The landscaping tool according to claim 5, wherein said releasable fastener is provided in the form of a threaded set screw.

12. The landscaping tool according to claim 5, wherein said releasable fastener is provided in the form of a locking cam.

13. The landscaping tool according to claim 1, wherein said landscaping tool further comprises a handle provided on said body portion.

14. The landscaping tool according to claim 13, wherein said handle is repositionable along said body portion.
